(19) United States
(12) Patent Application Publication
(10) Pub. No.: US 2012/0137817 A1
(43) Pub. Date: Jun. 7, 2012

(54) POWER CONTROL MEMBER FOR MANNED VEHICLE

(75) Inventor: ARTHUR WANG, KAOHSIUNG COUNTY (TW)

(73) Assignee: FREERIDER CORP., KAOHSIUNG COUNTY (TW)

(21) Appl. No.: 12/959,887

(22) Filed: Dec. 3, 2010

(51) Int. Cl. G05G 1/00

(52) U.S. Cl. 74/491

(57) ABSTRACT

A power control member for manned vehicles is revealed. The power control member includes a handle, a stem support and a power controller. The handle is sleeved and assembled with the stem support of a manned vehicle, and the power controller is arranged between the handle and the stem support. A power control shaft of the power controller shares the same axis with the handle and connects to the handle. Thereby rotation of the handle drives the power controller to control the direction and speed of the manned vehicle.

### BACKGROUND OF THE INVENTION

1. Field of the Invention

The present invention relates to a power control member for manned vehicles, especially to a power control member for manned vehicles that controls speed and direction of manned vehicles.

2. Description of Related Art

In a manned vehicle available now, a member for control of the movement mode or state is an operating rod 5 disposed on a stem support 4, as shown in FIG. 4. A variable resistor 6 is connected to a middle part of the operating rod 5. A pull part 51 is formed on each of two ends of the operating rod 5. Thereby when a user applies a force to the pull part 51 on one end of the operating rod 5, the operating rod 5 rotates around a connection area between the operating rod 5 and the variable resistor 6. At the same time, the variable resistor 6 is also moved and its resistance changes due to the rotation. Thus the direction and speed of the manned vehicle are controlled.

However, the operating rod is sleeved with and connected to the variable resistor only by the middle part thereof and the two ends of the operating rod are respectively in front of a handle. Thus its easy to touch or press the pull part on each of two ends of the operating rod by mistake and this cause movement of the manned vehicle as well as the safety problem of the users.

In order to solve above problems of the manned vehicle resulted from touching or pressing the operating rod by mistake, there is a need to provide a new design of a power control member for manned vehicles.

### SUMMARY OF THE INVENTION

Therefore it is a primary object of the present invention to provide a power control member for manned vehicles. The power control member controls the direction and speed of manned vehicles through rotation of a handle.

In order to achieve above object, a power control member for manned vehicles of the present invention includes a handle sleeved and assembled with a stem support of a manned vehicle, and a power controller disposed between the stem support and the handle. A power control shaft of the power controller is disposed on a position sharing the same axis with the handle and is connected to the handle. Thereby the power controller is also driven while rotating the handle so as to control the direction and speed of the manned vehicle.

In a preferred embodiment of the present invention, the power controller is a variable resistor.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an explosive view of an embodiment of a power control member according to the present invention;

FIG. 2 is an assembly view of an embodiment of a power control member according to the present invention;

FIG. 3 is a cross sectional view of an embodiment of a power control member according to the present invention;

FIG. 4 is a perspective view of a power control member available now.

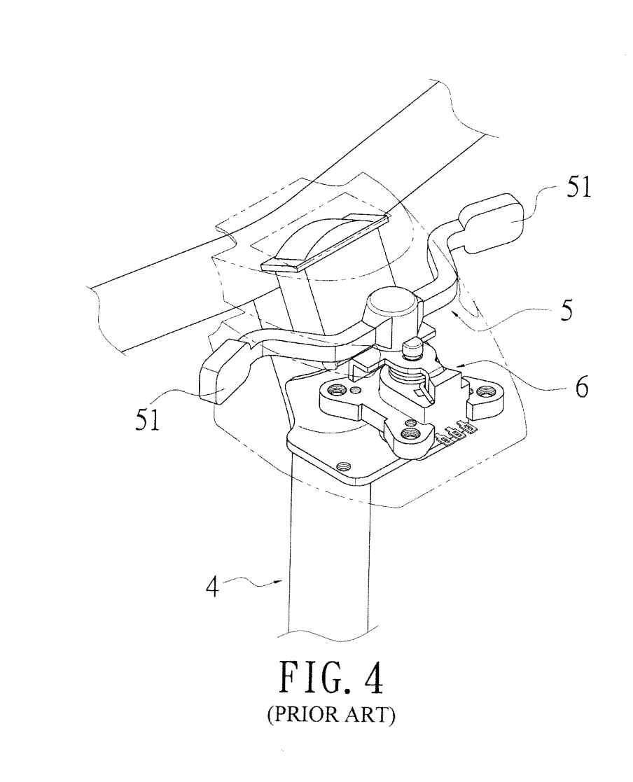

### DETAILED DESCRIPTION OF THE PREFERRED EMBODIMENT

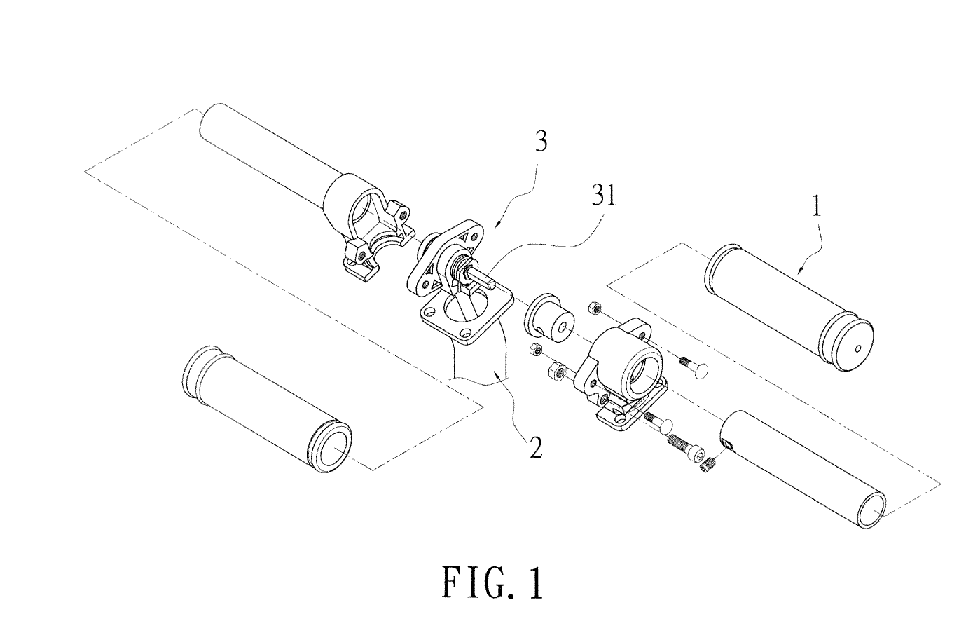

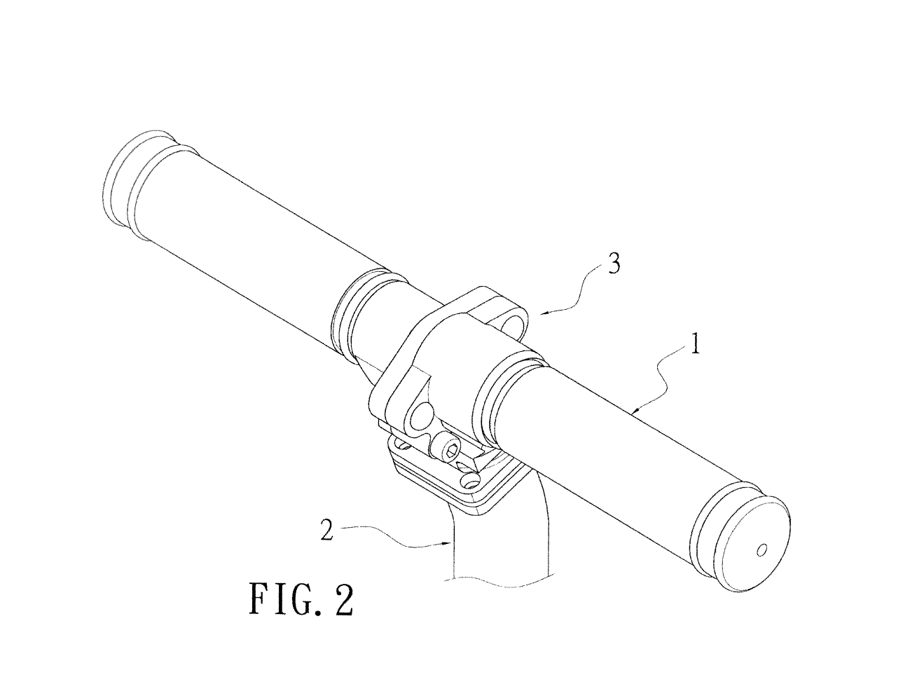

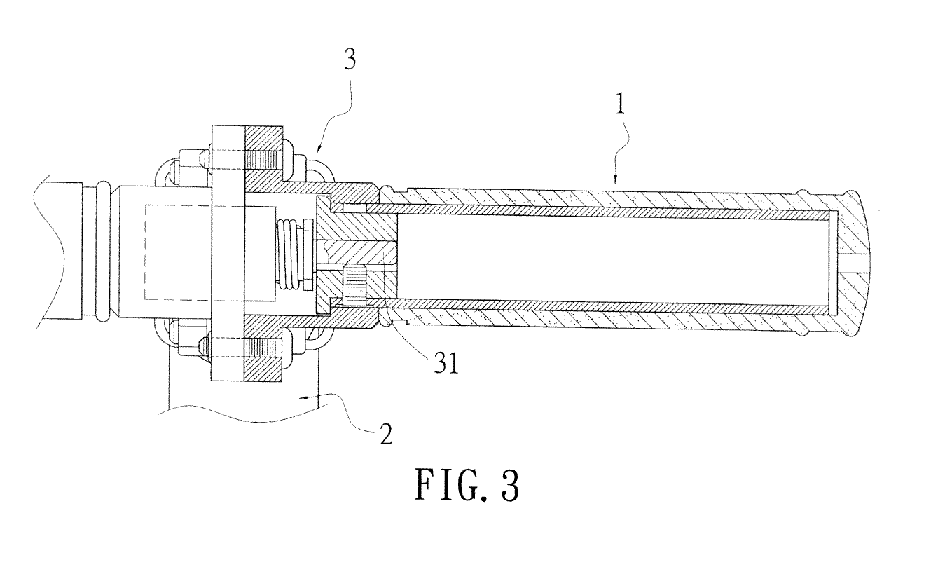

Refer from FIG. 1 to FIG. 3, a power control member of the present invention includes at least one handle 1 sleeved and assembled with a stem support 2 of a manned vehicle, and a power controller 3 arranged between the handle 1 and the stem support 2. The power controller 3 consists of a power control shaft 31 that shares the same axis with the handle 1 and connects to the handle 1.

Thereby the user can control the movement and speed of the manned vehicle by rotating the handle 1 after the manned vehicle being turned on. The handle 1 can be rotated to different directions. It is assumed that the manned vehicle is going to move forward once the handle 1 is rotated to a first direction, and the manned vehicle is going to move backward when the handle 1 is rotated to a second direction. Thus once the handle 1 is rotated toward the first direction, the manned vehicle starts to move forward. The speed of the vehicle is controlled by the rotation angle of the handle 1. While the handle 1 being rotated to the second direction, the manned vehicle moves backward and the moving speed is determined by the rotation angle of the handle 1.

In accordance with the above embodiment, it is learned that the power controller for control of the movement and speed of the manned vehicle is connected to the handle. Thus the manned vehicle is controlled by the rotated direction and the rotation angle of the handle so as to move forward and backward at high or low speed. The first direction of the rotated direction represents the forward movement while the second direction means the backward movement. Therefore, the operating and driving mode of the manned vehicle is similar to the operating and driving mode of motorcycles and users can operate the manned vehicle conveniently and easily.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A power control member for manned vehicles comprising:
a power controller disposed between a handle and a stem support of a manned vehicle, said power controller being activated responsive to a power control shaft to control propulsion direction and speed of the manned vehicle, the power control shaft extending coaxially with the handle; and
the handle being sleeved and connected to said power control shaft of said power controller.

2. The device as claimed in claim 1, wherein the power controller includes a variable resistor.

3. The device as claimed in claim 1, wherein the rotated direction of the handle controls propulsion direction for a manned vehicle and the angular displacement of the rotated handle controls the speed of the manned vehicle in that propulsion direction.
